(19) United States
(12) Patent Application Publication
(10) Pub. No.: US 2005/0061286 A1
(43) Pub. Date: Mar. 24, 2005

(54) Cylinder head for an internal combustion engine

(76) Inventors: Roberto Molina, Orbassano (IT); Davide Valzan, Villastellone (IT)

Correspondence Address: SUGHRUE MION, PLLC, 2100 PENNSYLVANIA AVENUE, N.W., SUITE 800, WASHINGTON, DC, 20037, US

(21) Appl. No.: 10/502,294

(22) PCT Filed: Jan. 20, 2003
(86) PCT No.: PCT/EP03/00506

(30) Foreign Application Priority Data
Jan. 22, 2002 (IT) TO2002 A 000063

(51) Int. Cl. F02F 1/00

(52) U.S. Cl. 123/193.3; 123/193.5

(57) ABSTRACT

A cylinder head for an internal combustion engine, which includes a bottom portion (2) intended to face at least one combustion chamber (CC) formed in a cylinder block (B) of the engine, and an upper portion (3) which extends on the other side of the bottom portion (2) from the said at least one combustion chamber (CC) and has a plurality of separate cavities (5a, 6, 7, 8) for the passage of fluids, the bottom portion (2) and the upper portion (3) being formed separately and intended to be joined together at a junction surface (10). In its joined condition, with the bottom portion (2) attached to the upper portion (3), the cylinder head includes sealing means (11, 15) interposed between the bottom plate (2) and the upper portion (3) for sealing off the plurality of cavities (5a, 6, 7, 8) at the junction surface (10), fixing means (14) being provided for holding the bottom portion (2) and the upper portion (3) fixed to the cylinder block (B).

The present invention relates in general to a cylinder head, for closing the upper part of the cylinder block of an internal combustion engine. More in particularly, the invention relates to a cylinder head having the characteristics described in the preamble to claim 1.

A cylinder head of this type is known, for example, from the European Patent EP 0 262 240, where an upper reinforcing portion and a flat base bottom portion are joined together by means of welding or brazing operations.

These operations, however, are both expensive and relatively complex to carry out. In addition, once obtained by this method, the junction between the two portions of the cylinder head is irreversible.

The object of the present invention is to provide a cylinder head which is relatively simple and economical to manufacture and which also allows the two portions to be separated.

This object is achieved according to the invention by providing a cylinder head having the characteristics defined in the claims.

A preferred but not limitative embodiment of the invention will now be described, with reference to the appended drawings, in which:

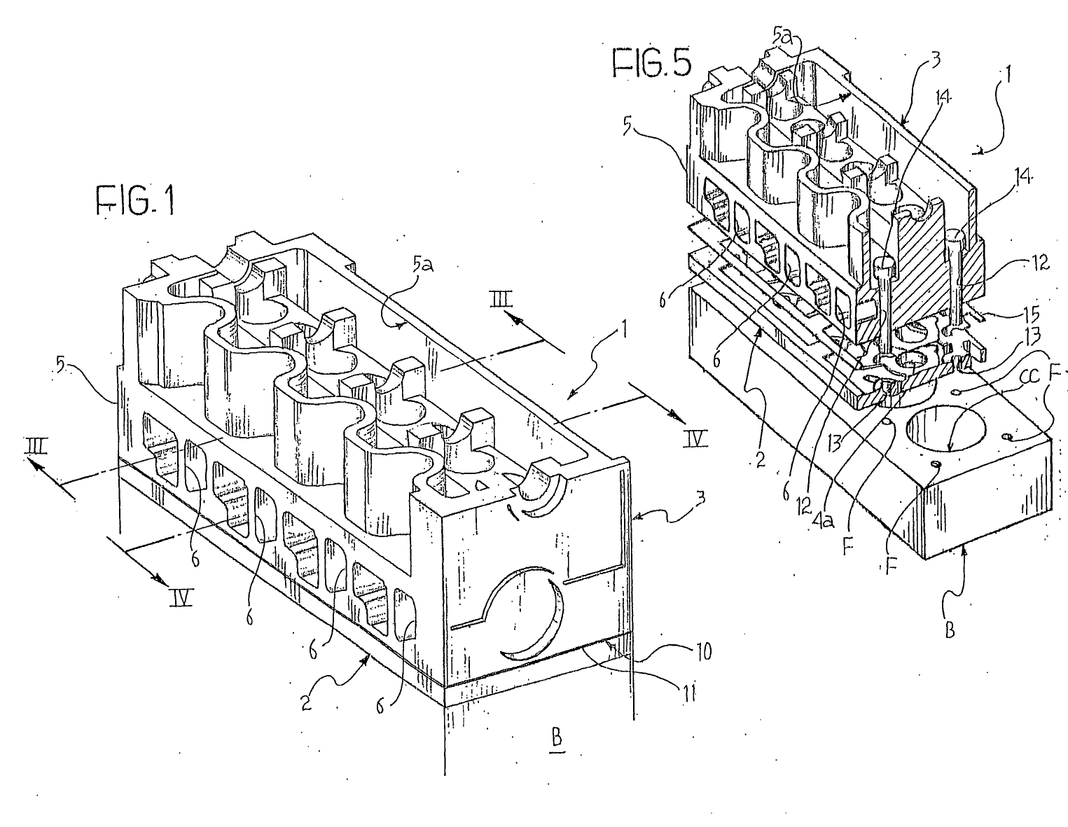

FIG. 1 is a perspective view of a cylinder head according to the present invention;

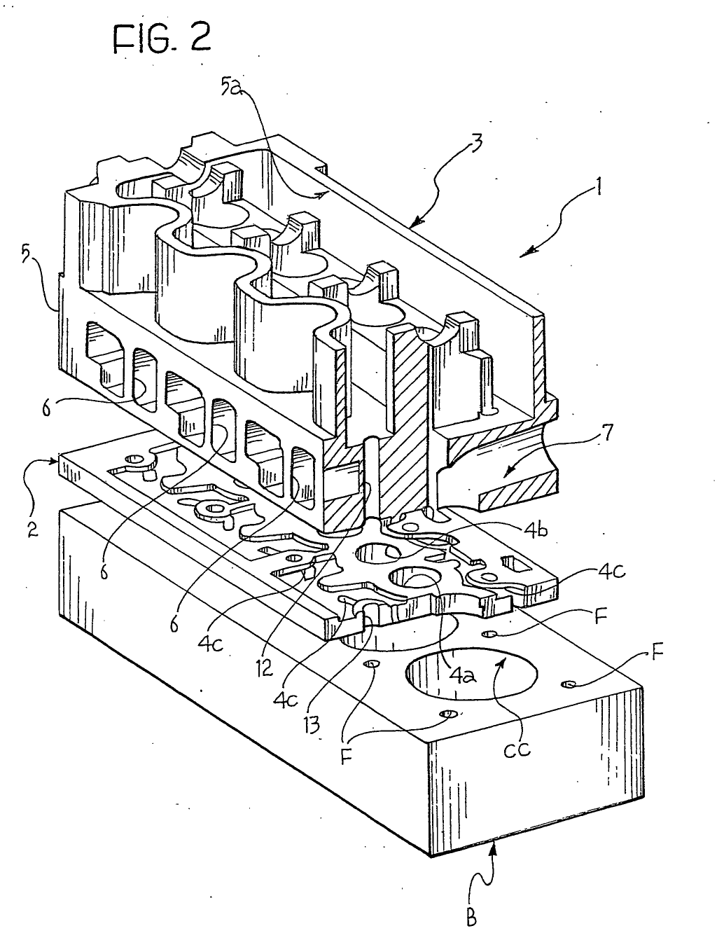

FIG. 2 is a partly sectioned, exploded view of the cylinder head of FIG. 1;

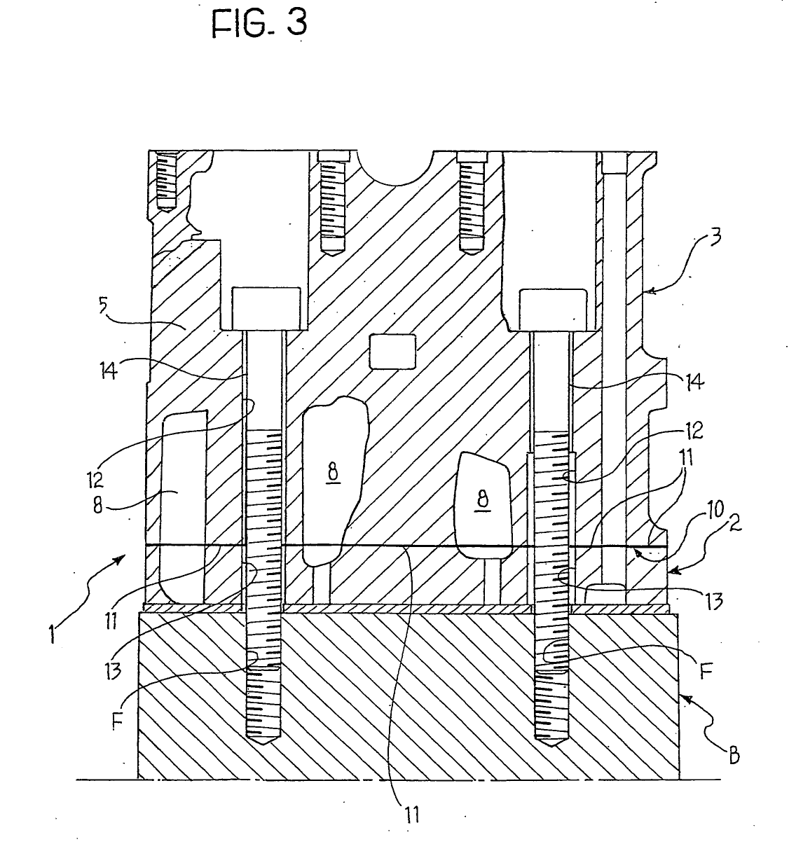

FIG. 3 is a cross section of the cylinder head of FIG. 1 taken on the line III-III;

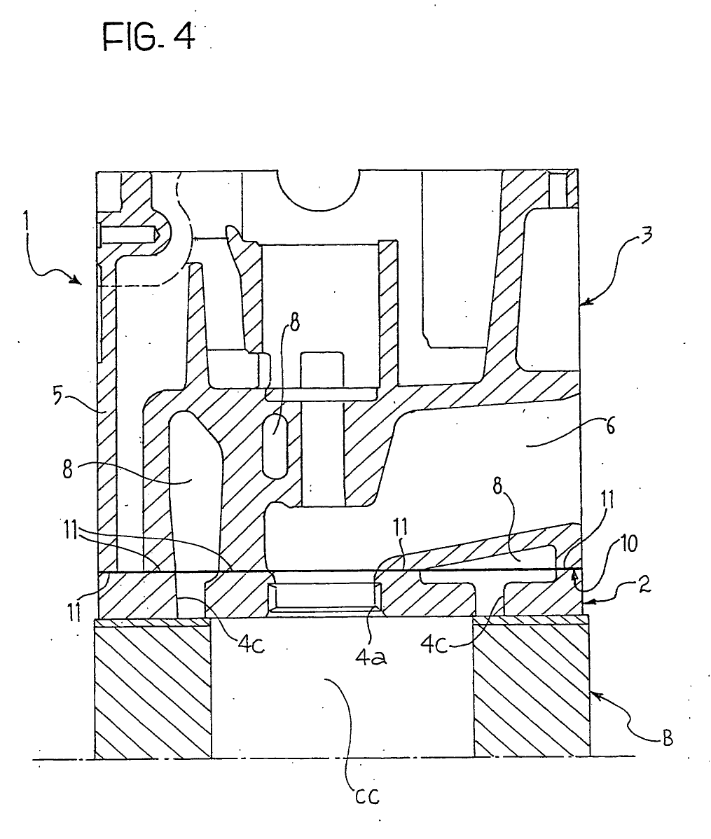

FIG. 4 is a cross section of the cylinder head of FIG. 1 taken on the line IV-IV; and

FIG. 5 is a partly sectioned, exploded view of an alternative embodiment of a cylinder head of the invention.

With reference to FIGS. 1 and 2, a cylinder head 1 includes a bottom plate 2, the lower surface of which faces combustion chambers CC of the engine cylinders, formed in a cylinder block B (shown schematically in the drawings), and an upper portion 3, which lies on the opposite side of the bottom plate 2 from the combustion chambers CC. The bottom plate 2 is traversed by apertures 4a with seats formed therein for the inlet valves (not shown) and other apertures, including apertures 4b for the exhaust valve seats (not shown) and apertures 4c for the passage of the cooling liquid.

With reference also to FIGS. 3 and 4, the upper portion 3 includes a body 5, the upper portion of which defines a cavity 5a for housing the timing members (not illustrated). Various cavities are formed inside the body 5 which form, among other things, inlet ducts 6, exhaust ducts 7 (one of which is shown in FIG. 2), and spaces 8 for the passage of the cooling liquid.

Since the lower surface of the bottom plate 2 is required to face the combustion chamber CC, it is preferably made of a material with a high resistance to high temperatures. For example, the plate 2 can be a machined piece, or can be produced in a casting or forming process, from an aluminium alloy or another light alloy of a heat-resistant type.

On the other hand, since the structure of the upper portion 3 is relatively complex, it is preferably obtained by casting an aluminium alloy or other light alloy, for example using a gravity or pressure casting method.

When the bottom plate 2 is joined to the upper portion 3, these portions are joined across a junction plane 10, substantially parallel to the coupling plane between the cylinder head and the cylinder block, and are arranged relative to each other in such a way that the openings in the plate 2 and the respective ducts opening from the lower face of the upper portion 3 are coaxially aligned.

For example, as shown in FIG. 4, the lower portion of the inlet duct 6 is aligned with the opening 4a for the inlet valve seat, while the spaces 8 are aligned with the openings 4c for passage of the cooling liquid.

A layer of adhesive material 11 with sealing properties is interposed between the two portions, positioned in the junction plane 10 on the areas of mutual contact. The purpose of this adhesive is to hold the two portions together in order to allow the cylinder head 1 to be manipulated and mounted on the cylinder block of the engine without any relative movement between the two portions. The adhesive is of a type which is resistant to high temperatures, preferably one which is polymerizable at room temperature. It could be a silicone adhesive which is polymerizable in the presence of moisture, for example.

The body 5 of the upper portion 3 and the bottom plate 2 have respective through holes 12 and 13 which are aligned coaxially when the cylinder head 1 is in its joined configuration.

Screws 14, illustrated in FIG. 3, extend through the holes 12 and 13 and engage tightly in holes F formed in the upper surface of the cylinder block B. When the cylinder head 1 is mounted on the cylinder block B, the screws 14 are able to withstand stress on the head 1, holding together the unit formed by the upper portion 3, the bottom plate 2 and the cylinder block B. The sealing adhesive at the junction plane 10 acts to insulate the various cavities for the passage of air, exhaust gas, cooling liquid and oil which extend through the cylinder head 1, thereby preventing fluids from infiltrating the junction plane 10 and thus mixing together.

FIG. 5 illustrates an alternative embodiment of the cylinder head of the invention, in which elements which correspond to those of the preceding drawings have been given the same reference numbers. A metal gasket 15 is interposed between the upper portion 3 and the bottom portion 2, operable, once the screws 14 have been tightened, to provide a seal which prevents any communication between the ducts which pass through the head 1.

It is preferable if a layer of adhesive is interposed in the areas of the junction plane where the upper portion 3 and the metal gasket 15 and the bottom plate 2 and the metal gasket 15 come into respective contact. Since the sealing function is achieved by the metal gasket 15, the adhesive layers are required only to hold together the unit during manipulation of the cylinder head 1.

Compared to conventional cylinder heads cast in one piece, it will be appreciated that the cylinder head of the invention makes it possible to make the bottom portion (which is not very thick) without having to use a sand core, and to simplify and reinforce the cores used to form the passages through the upper portion of the head. It is thereby possible to obtain passages for the cooling liquid which optimize the cooling of certain critical areas (between the valves, for example), and oil distribution channels of a complex configuration. In addition, it is possible to eliminate dispersion caused by positioning tolerances of the cavity cores within the shell, thereby ensuring that the walls are of a uniform thickness and that the flow of heat towards the cooling circuit is therefore even.

A cylinder head of the invention can usefully be used, for example, in motor vehicle engines. When manufacturing the upper portion of the head, it is in fact possible to use standard aluminium alloys or the like, which are relatively inexpensive and have only low resistance to mechanical stress, even in engines subject to high thermo-mechanical stress, such as the latest generation of direct fuelinjection diesel engines. The portion which interfaces with the cylinder block, however, which is subject to most of the stress, will be made of a high performance alloy.

Finally, in the event of stress being so high that an iron alloy (cast iron) is required, the cylinder head of the invention in any case makes it possible to keep down the overall mass of the engine, since the use of such alloys can be limited to only the portion facing the combustion chambers.

It is clear that the invention is not limited to the embodiment described and illustrated here, but that alterations can be made to the shape and arrangements of parts as well as to details of both construction and operation. For example, the portion facing the combustion chambers could be different from a plate, with its thickness varying through a horizontal plane and the junction could occur along a surface which is not flat, in dependence on any number of possible variants which might appear useful to those skilled in the art, without departing thereby from the scope of the invention, as defined in the following claims.

1. A cylinder head for an internal combustion engine, which includes a bottom portion (2), intended to face at least one combustion chamber (CC) formed in the cylinder block (B) of an engine, an upper portion (3) arranged on the side of the bottom portion (2) remote from the said at least one combustion chamber (CC) and having a plurality of separate cavities (5a, 6, 7, 8) for the passage of fluids, the bottom portion (2) and the upper portion (3) being manufactured separately with a view to being joined together along a junction surface (10), and sealing means (11, 15) interposed between the bottom plate (2) and the upper portion (3) in order to seal the various cavities (5a, 6, 7, 8) at the junction surface (10) when the bottom portion (2) is joined to the upper portion (3), fixing means (14) being provided for securing the bottom portion (2) and the upper portion (3) joined together and to the cylinder block (B), characterised in that the said sealing means (11, 15) include a metal gasket (15), the metal gasket (15) being fixed to the said bottom portion (2) and to the said upper portion (3) by means of at least one layer of adhesive material when the head is in its joined condition.

2. A cylinder head according to claim 1, in which the said fixing means (14) cooperate in use with the said sealing means (11, 15) in sealing the cavities (6, 8) for the passage of fluids.

3. A cylinder head according to claim 1, in which the said sealing means (11, 15) include at least one layer of adhesive sealing material (11), arranged on the junction surface (10).

4. A cylinder head according to claim 3, in which the said adhesive is polymerizable at room temperature.

5. A cylinder head according to claim 4, in which the said adhesive is a silicone adhesive which is polymerizable in the presence of moisture.

6. A cylinder head according to claim 1, in which the said fixing means (14) include screw means (14) which extend through holes (12, 13) formed through the bottom portion (2) and through the upper portion (3) in such a way that they are able to engage fixing holes (F) formed in the cylinder block (B).

7. A cylinder head according to claim 1, in which the upper portion (3) and the bottom portion (2) are made of a light alloy, preferably aluminium, with the bottom portion (2) being made of an alloy with a greater heat resistance.

8. A cylinder head according to claim 1, in which the said junction surface (10) is substantially flat.
